(19) United States
(12) Patent Application Publication
(10) Pub. No.: US 2016/0069658 A1
(43) Pub. Date: Mar. 10, 2016

(54) Measurement Devices

(71) Applicant: Anthony Leo Klein, Freeport, NY (US)

(72) Inventor: Anthony Leo Klein, Freeport, NY (US)

(21) Appl. No.: 14/943,930

(22) Filed: Nov. 17, 2015

Related U.S. Application Data
(63) Continuation of application No. 14/666,190, filed on Mar. 23, 2015, now abandoned.
(60) Provisional application No. 61/969,060, filed on Mar. 21, 2014.
(60) Provisional application No. 62/080,846, filed on Nov. 17, 2014.

(51) Int. Cl. G01B 3/10

(52) U.S. Cl. CPC G01B 3/1084; G01B 2003/1087

(57) ABSTRACT

A tape measure includes a measuring tape extending from a tape measure body. A square may pivot between a first, retracted position alongside of the tape measure body and a second, in use position, extending outward from the tape measure body. The tape measure can include at least two levels disposed orthogonal to one another. The tape measure can also include at least two laser lights, emitting light orthogonal to one another. The tape of the tape measure may include measurement designations shown in one or more languages. Additionally, the tape of the tape measure may include measurements in various formats, including SAE, metric, or the like. The measurement designations may be similarly applied to a ruler of various lengths, such as 12-inch, 18-inch, 36-inch or 1-meter, for example.

### CROSS-REFERENCE TO RELATED APPLICATIONS

This application is a continuation-in-part of U.S. patent application 14/666,190, filed Mar. 23, 2015, which claims the benefit of priority to U.S. provisional patent application No. 61/969,060, filed Mar. 21, 2014. This application further claims the benefit of priority to U.S. provisional patent application No. 62/080846, filed Nov. 17, 2014. The contents of each of which are herein incorporated by reference.

### BACKGROUND OF THE INVENTION

The present invention relates to measurement devices and, more particularly, to a tape measure that acts as an all-in-one measuring tool, having a horizontal and vertical laser line level, two bubble levels and a fold-down square on the side and a tape measure or ruler that includes multiple languages.

Tape measures are typically used to make various measurements. When measuring lengths from an edge, a user often extends the tape measure from the edge and makes their mark. However, if the tape is angled more or less than 90 degrees from the edge, the measure can be incorrect. As the distance measured gets longer, it can be more difficult to keep the tape square with the edge.

In addition, there are situations where a user desires to measure a distance to a surface that is plumb with the measuring starting point. For example, a user measuring a distance from a roof eave to the ground would want to ensure the measurement is made along a plumb line. If the measurement is made at an angle in either direction, the measurement may be incorrect. Typical tape measures offer no way to ensure the measurement is plumb.

Moreover, tape measures and rulers typically only include numbers and tick marks spaced apart at pre-defined intervals (such as 1/16 inch, ⅛ inch or 1/32 inch). Some tape measures label these tick marks for user convenience, but these marks are usually only provided in one language, typically in English.

In addition, in an educational environment, rules used in the classroom are much like tape measures, where they either have just numerical markings and tick marks, or have measurement designations in only the English language.

As can be seen, there is a need for a tape measure that has integrated tools to make square and plumb measurements as well as a need for a tape measure or ruler that includes designations in more than one language.

### SUMMARY OF THE INVENTION

In one aspect of the present invention, a tape measure comprises a tape extending from a tape measure body; an alignment tool positionable between a first position disposed against a side of the tape measure body, and a second position, disposed in a use position; and at least one laser emitting a laser light from the tape measure body, wherein the tape includes measurement designations in a first language and a second language.

In another aspect of the present invention, a tape measure comprises a tape extending from a tape measure body, wherein the tape includes measurement designations in a first language and a second language; and the measurement designations relate to the tape by providing a textual representation of distance from one end of the tape.

In a further aspect of the present invention, a ruler comprises an elongated body; and measurement designations in a first language and a second language, wherein the measurement designations relate to the elongated body by providing a textual representation of distance from one end of the elongated body.

These and other features, aspects and advantages of the present invention will become better understood with reference to the following drawings, description and claims.

### BRIEF DESCRIPTION OF THE DRAWINGS

FIG. 1 is a front perspective view of a tape measure according to an exemplary embodiment of the present invention;

FIG. 2 is a side view of the tape measure of FIG. 1;

FIG. 3 is a back perspective view of the tape measure of FIG. 1;

FIG. 4 is a side view of the tape measure of FIG. 1, illustrating an angle arm extended to provide a square, according to an exemplary embodiment of the present invention;

FIG. 5 is a back perspective view of the tape measure of FIG. 4, illustrating one possible placement of a laser light according to an exemplary embodiment of the present invention;

FIG. 6 is a detailed top view of a tape of the tape measure of FIG. 1 or a detailed top view of a stand-alone ruler according to another exemplary embodiment of the present invention;

FIG. 7 is a detailed top perspective view of a tape of a tape measure or a ruler illustrating measurement designations in two languages, according to an exemplary embodiment of the present invention;

FIG. 8 is a detailed top view of a tape of a tape measure or a ruler illustrating measurement designations in a single language and two measurement scales, according to an exemplary embodiment of the present invention;

FIG. 9A is a detailed front view of a first section of a ruler according to an exemplary embodiment of the present invention;

FIG. 9B is a detailed front view of a second section of a ruler according to an exemplary embodiment of the present invention;

FIG. 10A is a detailed back view of a first section of a ruler according to an exemplary embodiment of the present invention; and

FIG. 10B is a detailed back view of a second section of a ruler according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a tape measure having a measuring tape extending from a tape measure body. A square may pivot between a first, retracted position alongside of the tape measure body and a second, in use position, extending outward from the tape measure body. The tape measure can include at least two levels disposed orthogonal to one another. The tape measure can also include at least two laser lights, emitting light orthogonal to one another. The tape of the tape measure may include measurement designations shown in one or more languages. Additionally, the tape of the tape measure may include measurements in various formats, including SAE, metric, or the like.

The measurement designations may be similarly applied to a ruler of various lengths, such as 12-inch, 18-inch, 36-inch or 1-meter, for example. As used herein, the term “ruler” refers to any rigid measurement device. This could also be a meter-stick, a tri-square, a drywall square, or other similar rigid measurement device.

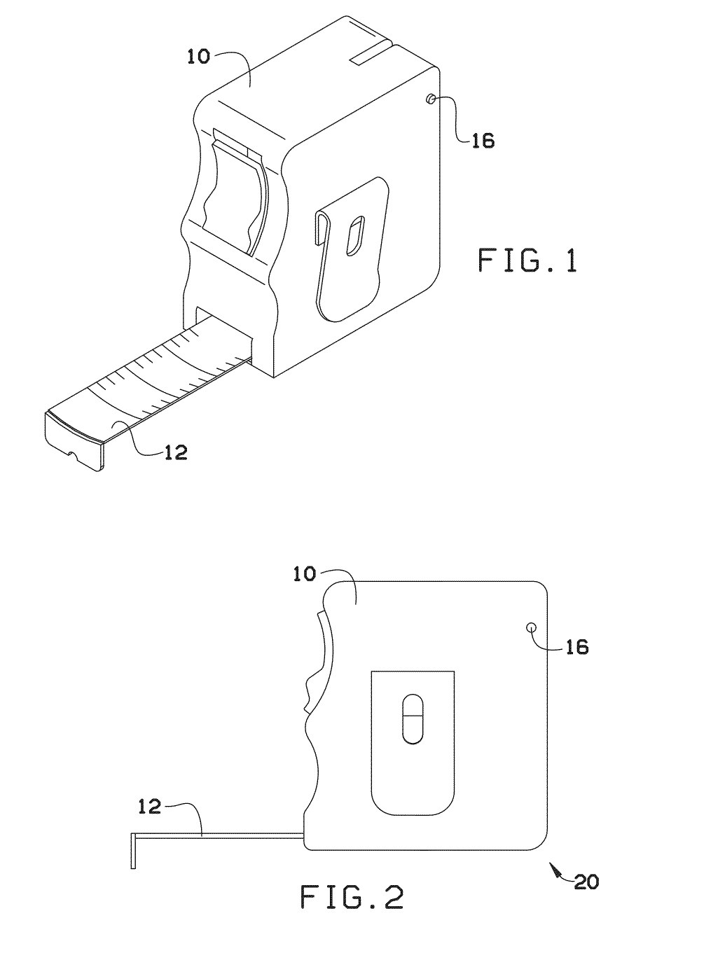

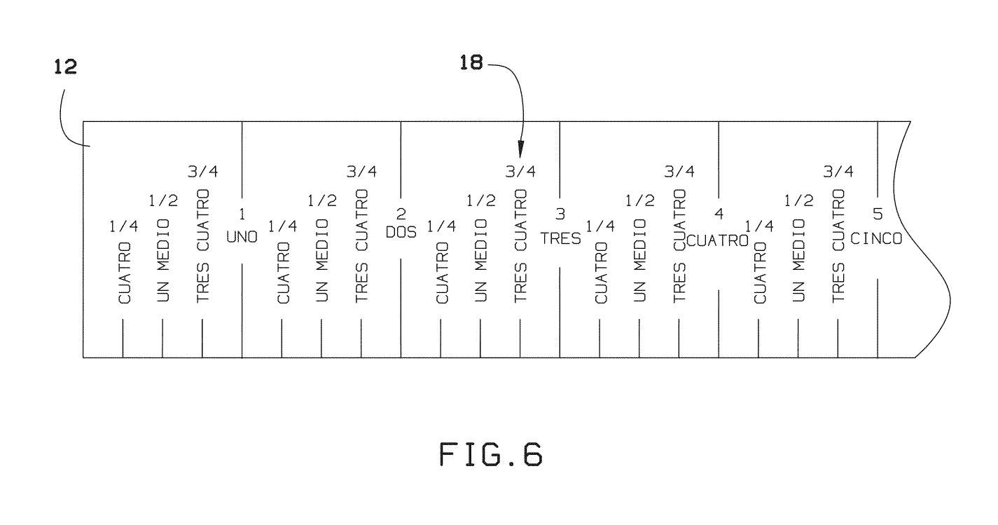

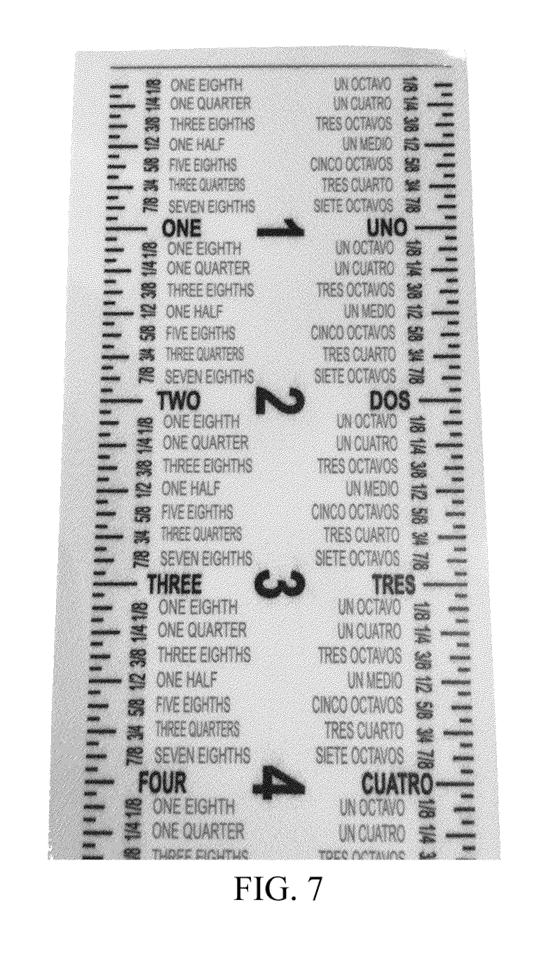

Referring now to FIGS. 1 through 6, a tape measure can include a tape 12 removable and restorable in a tape measure body 10. The tape 12 can include Spanish language text 18 to help indicate various measurements for those more fluent in Spanish. In some embodiments of the present invention, other languages may be used to indicate the measurement designations on the tape 12. In some embodiments, as shown in FIG. 7, the tape (or a ruler, as discussed below) may include both English and Spanish language measurement designations.

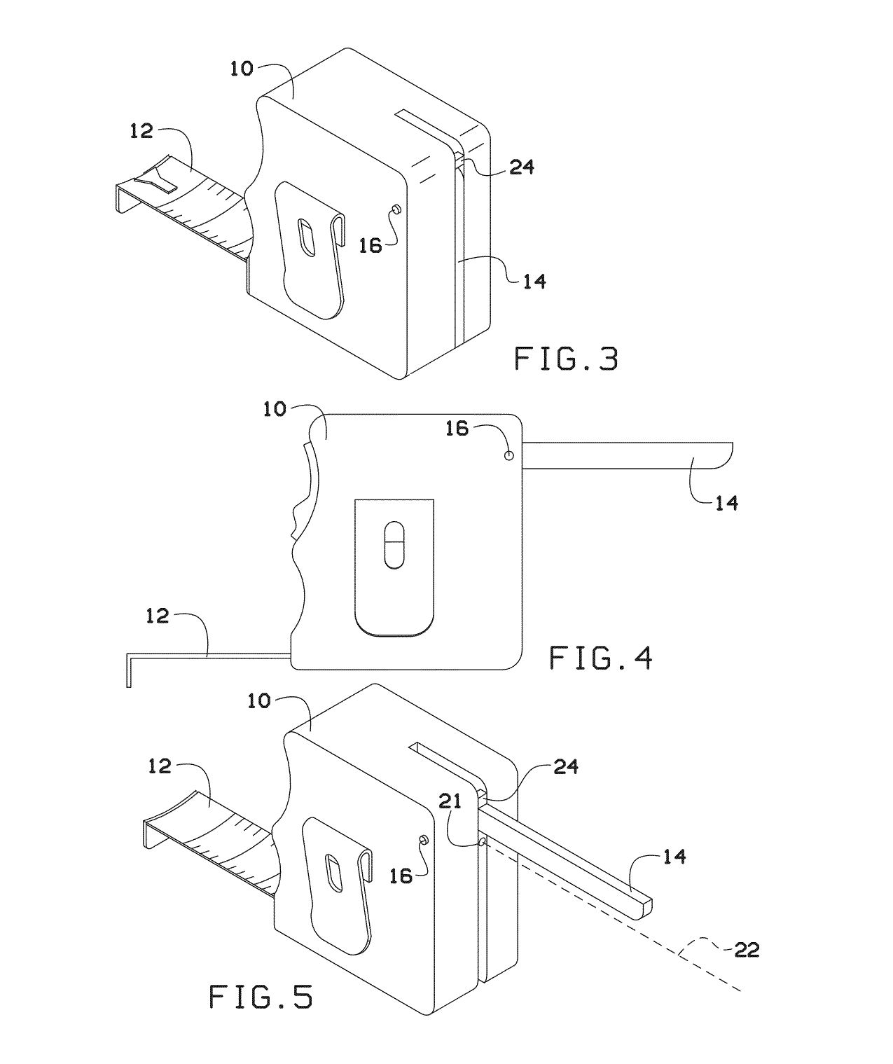

A back side (opposite the side from which the tape extends) of the tape measure body 10 can include an angle arm 14 that can pivot about a pivot axis 16. The angle arm 10 can pivot between a first position, where the angle arm 14 rests flush with the back side of the tape measure body 10 (as shown in FIGS. 2 and 3) and a second position, where the angle arm 14 extends to form an angle with the back side of the tape measure body 10 (as shown in FIGS. 4 and 5). A stop 24 can be provided to limit the pivot of the angle arm 14 so that, when fully pivoted away from the tape measure body 10, the angle arm 14 extends at a right angle relative to the back side of the tape measure body 10.

In some embodiments, the angle arm may be a triangular shaped feature that can extend from a side of the tape measure to provide a surface generally perpendicular to the tape. This embodiment may be useful for aligning the tape square with a surface.

When the angle arm 14 is extended, a laser light 21 can be activated that can emit a laser beam 22 out from the back side of the tape measure body 10. While FIG. 5 shows the laser light 21 disposed below the angle arm 14, in some embodiments, the laser light 21 can be disposed above the angle arm 14. In still other embodiments, a laser light 21 can extend the laser beam 22 both above and below the angle arm 14, providing a straight line that is at a right angle relative to the plane of the back side of the tape measure body 10.

In some embodiments, the laser light source can extend a light outward from the tape measure 10 in a first direction and a second direction, orthogonal to the first direction. In some embodiments, a laser light may shine in a third direction, orthogonal to the first and second directions. A cover may be disposed over each of the laser light emission sources to block the light and protect users. In some embodiments, an on-off switch may be disposed to turn the laser lights on and off.

When equipped with a laser light, the tape measure can be provided with a power source (not shown) such as a battery disposed inside the tape measure body. The laser light can be turned on and off by detecting whether the angle arm 14 is in the first, closed position, or in the second, open position.

In some embodiments, the tape measure 10 can include a first level, such as a bubble level, running generally perpendicular to the tape 12 (defined as the X-direction). A second level can run generally perpendicular to the first level and generally parallel to the direction of extension and retraction of the tape 12 (defined as the Y-direction). In some embodiments, a third level may be disposed in the Z-direction on a back side, for example, of the tape measure 10.

The tape measure of the present invention may be useful in various measuring situations, including measuring lengths from a square starting point along an edge and measuring in a level path. The tape measure can also be used to help sheetrock cutting, picture hanging, and many other uses.

Referring now to FIG. 7, in some embodiments, the multiple language (such as English and Spanish, for example) measurement designations may be used on a ruler. The ruler may be made from various materials, such as metal, wood, plastic or the like. The markings on the ruler may designate distances from one edge of the ruler.

While the designations of FIG. 7 show measurement designations every ⅛ inch, these textual measurement designations may be provided at greater or less distances. In some embodiments, the textual measurement designations may be different between various sections of the ruler. For example, between one inch and two inch, the measurement designations may label every ¼ inch, between two inch and three inch, the measurement designations may label every ⅛ inch mark, and between three inch and four inch, the measurement designations may label every 1/16 inch mark.

The ruler may include tick marks every ⅛ inch, every 1/16 inch, every 1/32 inch or the like. As discussed above, the textual measurement designations may be present on each tick mark, every other tick mark (as shown in FIG. 7), or the like. The measurement designation may (as shown in FIG. 7) or may not include the numerical fractional representation.

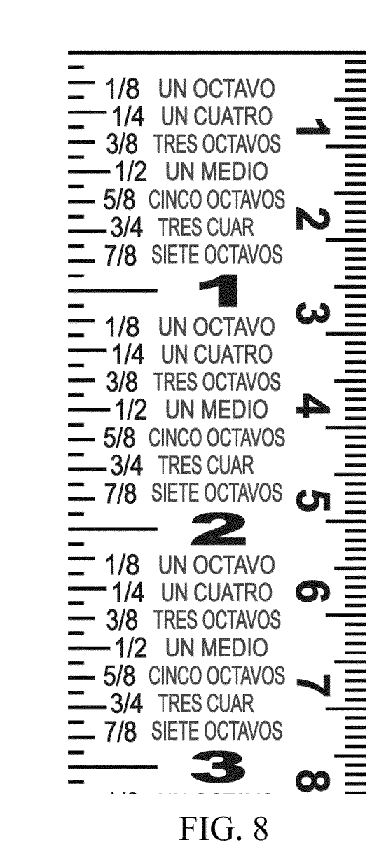

While the previously described Figures show SAE measurements, any measurement standard may be used on the tape measure or ruler. For example, as shown in FIG. 8, metric measurements may be used. In some embodiments, the ruler may include SAE measurements on one side thereof and metric measurements on the other side thereof. In other embodiments, SAE measurements and metric measurements may be disposed on the same side of the ruler. In some embodiments, the measurement designations may be in a single language (as shown in FIG. 8) or may include two languages. Where multiple measurement scales are provided, the textual measurement designations may apply to one or both of the measurement scales.

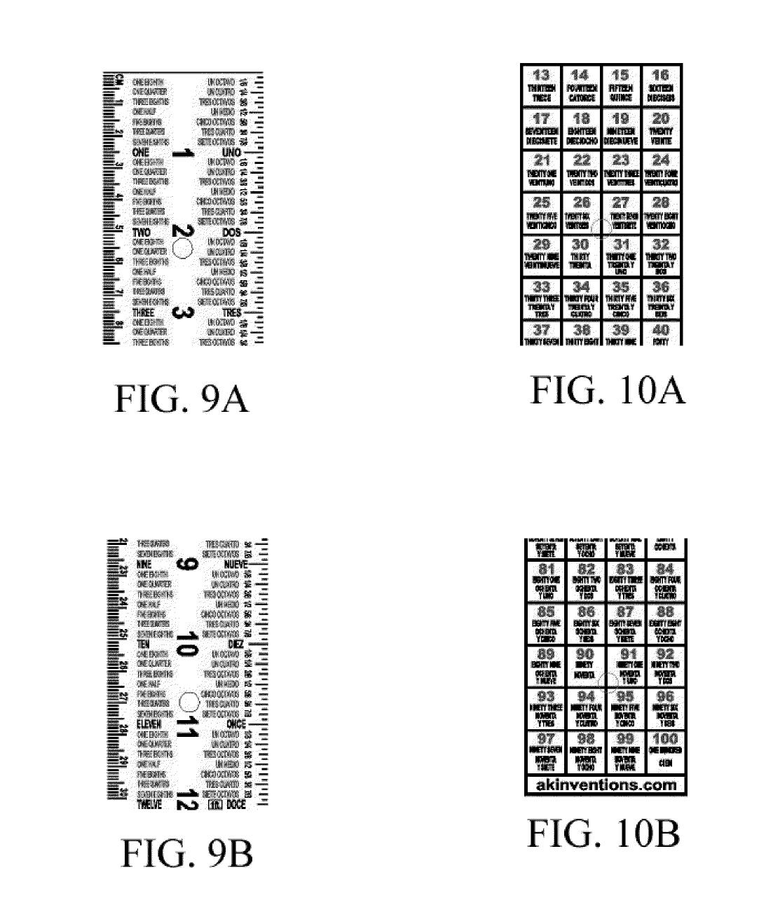

FIGS. 9A-10B show an exemplary embodiment of a ruler that may be formed in various lengths, such as in a foot-long length. The ruler may have multiple languages on each side, with a front side showing measurements in one or more scales and the back side showing multiple languages with respect to counting from where the front side leaves off (for example, for a 12-inch ruler, the back side can start counting from thirteen). The back side may count to any given number, such as one hundred, for example.

While the discussion of FIGS. 7-10B above refer to rulers, the same concepts may also apply to the tape of a tape measure.

The ruler may be especially useful as a learning tool for teaching numbers and fractions in more than one language. In this embodiment, one side of the ruler may include numerical translation between the languages from one to one hundred, for example, or any numerical range.

The ruler and tape measure may be provided in various widths and sizes, as may be useful and convenient for their particular purpose. For example, as may be known in the art, a longer tape measure may be made with a wider blade to keep the blade from bending over a longer distance. Other sizes and shapes are contemplated within the scope of the present invention.

It should be understood, of course, that the foregoing relates to exemplary embodiments of the invention and that modifications may be made without departing from the spirit and scope of the invention as set forth in the following claims.

What is claimed is:

1. A tape measure comprising:
a tape extending from a tape measure body;
an alignment tool positionable between a first position disposed against a side of the tape measure body, and a second position, disposed in a use position; and
at least one laser emitting a laser light from the tape measure body, wherein
the tape includes measurement designations in a first language and a second language.

2. The tape measure of claim 1, wherein the at least one laser includes two or more lasers emitting laser light in orthogonal directions.

3. The tape measure of claim 1, wherein the first language is English and the second language is Spanish.

4. The tape measure of claim 1, wherein the measurement designations relate to the tape by providing a textual representation of distance from one end of the tape.

5. A tape measure comprising:
a tape extending from a tape measure body, wherein
the tape includes measurement designations in a first language and a second language; and
the measurement designations relate to the tape by providing a textual representation of distance from one end of the tape.

6. The tape measure of claim 5, further comprising:
an alignment tool positionable between a first position disposed against a side of the tape measure body, and a second position, disposed in a use position; and
at least one laser emitting a laser light from the tape measure body.

7. The tape measure of claim 6, wherein the at least one laser includes two or more lasers emitting laser light in orthogonal directions.

8. The tape measure of claim 5, wherein the first language is English and the second language is Spanish.

9. A ruler comprising:
an elongated body; and
measurement designations in a first language and a second language, wherein
the measurement designations relate to the elongated body by providing a textual representation of distance from one end of the elongated body.

10. The ruler of claim 9, wherein the first language is English and the second language is Spanish.
